(19) United States
(12) Patent Application Publication
(10) Pub. No.: US 2008/0287084 A1
(43) Pub. Date: Nov. 20, 2008

(54) Antenna Device and Portable Radio Communication Device Comprising Such Antenna Device

(75) Inventors: Christer Krebs, Akersberga (SE); Magnus Olsson, Osterskar (SE); Jonas Starck, Furusund (SE); Ishimiya Katsunori, Tokyo (JP); Axel von Arbin, Taby (SE)

Correspondence Address: HOLLAND & HART, LLP, P.O BOX 8749, DENVER, CO, 80201, US

(73) Assignee: AMC Centurion AB, Akersberga (SE)

(21) Appl. No.: 10/563,458

(22) PCT Filed: Jul. 9, 2004
(86) PCT No.: PCT/SE04/01123

§ 371 Date: Oct. 16, 2006

(30) Foreign Application Priority Data
Jul. 11, 2003 (SE) 0302054-2

(51) Int. Cl. H04B 1/18

(52) U.S. Cl. 455/271

(57) ABSTRACT

An antenna device for a portable radio communication device adapted for receiving radio signals comprises an internal radiating element (10) comprising at least one feeding portion (21, 22) connected to a receiver circuit (40). The radiating element (10) comprises an electrical impedance (30) that is controllable in dependence on the desired frequency range of the received signals, wherein the feeding portion (21, 22) is connected to a feeding input (40a, 40b) on the receiver circuit and the control input of the controllable electrical impedance (30) is connected to an output (40c) on the receiver circuit (40) intended for the control of the VCO resonance frequency of the receiver circuit. In that way an antenna device can be provided inside the casing of a small sized portable radio communication device, which has good performance throughout a narrow sub-band of a frequency band having a relatively low frequency, wherein the narrow sub-band can be adjusted in frequency so as to cover the entire frequency band, such as the FM radio band.

### FIELD OF INVENTION

The present invention relates generally to antenna devices and more particularly to an antenna device for use in a radio communication device, such as a mobile phone, which is adapted for radio signals having a relatively low frequency, such as radio signals in the FM band.

### BACKGROUND

Internal antennas have been used for some time in portable radio communication devices. There are a number of advantages connected with using internal antennas, of which can be mentioned that they are small and light, making them suitable for applications wherein size and weight are of importance, such as in mobile phones.

However, the application of internal antennas in a mobile phone puts some constraints on the configuration of the antenna element. In particular, in a portable radio communication device the space for an internal antenna arrangement is limited. These constraints may make it difficult to find a configuration of the antenna that provides for a wide operating band. This is especially true for antennas intended for use with radio signals of relatively low frequencies as the desired physical length of such antennas are large compared to antennas operating with relatively high frequencies.

One specific application operating in a relatively low frequency band is the FM radio application. The FM band is defined as frequencies between 88-108 MHz in Europe or between 76-110 MHz in the USA. Conventional antenna configurations, such as loop antennas or monopole antennas, fitted within the casing of a portable radio communication device will result in unsatisfactory operation in that the antenna either has too bad performance over a sufficiently wide frequency band or sufficient performance over a too narrow frequency band.

Instead, a conventional FM antenna for portable radio communication devices is provided in the headset wire connected to the communication device. This configuration with a relatively long wire permits an antenna length that is sufficient also for low frequency applications. However, if no external antenna is permitted this solution is obviously not feasible.

### SUMMARY OF THE INVENTION

An object of the present invention is to provide an internal antenna device for use in a portable radio communication device, which operates with sufficient performance throughout a frequency band having a relatively low frequency, such as the FM radio band.

Another object of the present invention is to provide such an antenna device involving few components.

The invention is based on the realisation that an antenna can be provided inside the casing of a portable radio communication device, which has good performance throughout a narrow sub-band of a frequency band having a relatively low frequency, and that the narrow sub-band can be adjusted in frequency so as to cover the entire frequency band.

According to the present invention there is provided an antenna device as defined in appended claim 1.

By providing a controllable electrical impedance in the radiating element, the range of a relatively narrow resonance frequency band can be adjusted, thereby providing for a small sized antenna device operating in a relatively low frequency band.

There is also provided a radio communication device comprising such an antenna device.

The invention provides for a solution involving very few components because the same signal that is already used for controlling the resonance frequency of the receiver circuit is also used for controlling the operating frequency band of the antenna device

Further preferred embodiments are defined in the dependent claims.

### BRIEF DESCRIPTION OF DRAWINGS

The invention is now described, by way of example, with reference to the accompanying drawings, in which:

FIG. 1 is an schematic diagram showing an antenna device according to the invention having a variable impedance;

FIG. 2 is a diagram similar to the one of FIG. 1 but showing a variable capacitance;

FIG. 3 is a diagram showing in more detail an antenna device according to the invention connected to an FM receiver circuit;

FIG. 4 is a diagram similar to the one of FIG. 3 but with an alternative embodiment of the antenna device according to the invention;

FIG. 5 is a perspective view, partially in section, of an antenna device according to the invention mounted in a portable radio communication device;

FIG. 6 is a perspective view showing an alternative antenna configuration in a portable radio communication device;

FIG. 7 is a plan view showing the positioning of yet an alternative embodiment of the antenna device according to the invention in a portable radio communication device; and

FIG. 8 is a view showing the combination of three radiating elements.

### DETAILED DESCRIPTION OF THE INVENTION

In the following, a detailed description of preferred embodiments of an antenna device and a portable radio communication device according to the invention will be given. In the several embodiments described herein, the same reference numerals are given to identical parts of the different embodiments.

In the following description and claims, the term radiating element is used. It is to be understood that this term is intended to cover electrically conductive elements arranged for receiving and/or transmitting radio signals. Also, by the term feeding device should be understood any device that can receive and/or transmit signals from/to a radiating element.

First with reference to FIG. 1, the general configuration of an antenna device according to the invention is shown, in this case a loop antenna. The antenna, generally designated 1, comprises a loop of thin electrically conductive wire. First and second feeding portions 21 and 22 are connected to the loop and are adapted for connection to a feeding device. The feeding can be either balanced or unbalanced. In the case of unbalanced feed, the second feeding portion 22 is connected to a ground plane, such as a conductive area on a PCB, which will have the effect of a stub match. This feeding arrangement provides for a T-match network, which increases the radiation resistance. Also, a loop antenna is relatively stable and does not detune easily, which is an advantage in a portable radio communication device which is operated in different locations and orientations etc.

The antenna volume in a portable radio communication device is small, which results in a physically small antenna compared to the wavelength. This leads to a non-resonant loop antenna and an electrical impedance 30 is provided somewhere in the radiating element to provide a resonant antenna in the desired frequency range. However, with a fixed impedance the antenna will operate with a relatively small bandwidth, such as about 1 MHz. In order to be able to cover the entire desired bandwidth, in the case of the FM band about 20 MHz, the impedance 30 is provided as a variable impedance, as indicated by the arrow in FIG. 1. The variable impedance functions as a tuning circuit by means of which the resonant frequency band of the antenna device 1 can be adjusted.

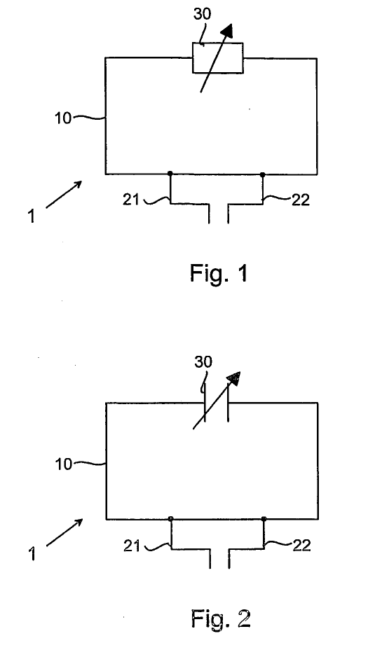

In a preferred embodiment shown in FIG. 2 the electrical impedance 30 is a varactor diode functioning as a variable capacitance.

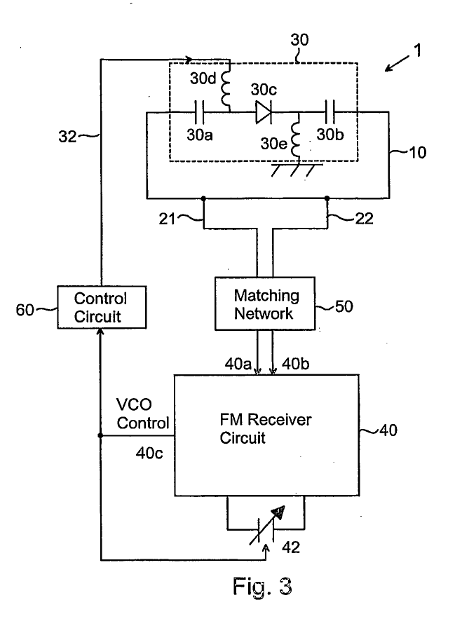

An implementation of the general idea expressed in FIGS. 1 and 2 will now be described with reference to FIG. 3. The general configuration of the antenna device 1 is retained. Thus, it comprises a loop 10 of electrically conductive wire. The feeding portions 21 and 22 are connected to an FM receiver circuit 40 via a matching network 50, as is conventional. The variable capacitance 30, indicated by dashed lines in FIG. 3, comprises a first capacitance 30a, a diode 30c, and a second capacitance 30b, all connected in series in the loop 10. A first inductance 30d is connected between the first capacitance 30a and the diode 30c. A second inductance 30e is connected between ground and the junction between the second capacitance 30b and the diode 30c. A control line 32 is connected to the first inductance 30d, as will be described in more detail below, while the second inductance 30e is connected to ground.

The FM receiver circuit 40, which could be a conventional circuit manufactured by Philips Semiconductors and sold under the name HVQFN40, comprises two feeding inputs 40a, 40b which are connected to the antenna loop 10, as has been explained above. The FM receiver circuit 40 also comprises a VCO control output 40c which conventionally is used for controlling the resonance frequency of an external tuning circuit 42 which is used to get the correct resonance frequency for the receiver 40. In the preferred embodiment the tuning circuit comprises a voltage controlled oscillator (VCO), the frequency of which is controlled by means of a voltage applied to the VCO. A VCO control output 40c which is found on the FM receiver circuit 40 is connected to the VCO and a voltage is output from the output 40c so as to generate the correct VCO frequency for the desired operating frequency of the FM receiver circuit. The VCO is in turn connected to inputs 40d, 40e on the FM receiver circuit adapted to receive the correct resonance frequency for demodulating the received radio signal to base band frequency.

Besides being connected to the VCO 42, the VCO control output 40c is also connected to the varactor 30 via a control circuit 60 adapted to amplify or otherwise adapt the VCO control signal to the operation of the varactor 30. More specifically, the conditioned VCO control signal is applied to the first inductance 30d of the varactor via the control line 32. With correct adaptation of the VCO control signal, the antenna device 1 will exhibit an operating frequency range that corresponds to the current operating frequency range of the FM receiver circuit 40, i.e., the frequency range determined by the current VCO resonance frequency. The adaptation of the VCO control signal and the choice of values for the components 30a-e are within the skills of the person skilled in the art.

This embodiment uses the general idea of having a relatively narrow-banded antenna device with an operating band that is adjustable by means of an adjustable impedance in the antenna, in this case an adjustable capacitance. The arrangement shown in FIG. 3 comprises very few components because the same signal, VCO control, that is already used for controlling the resonance frequency of the VCO 42 is also used for controlling the operating frequency band of the antenna device 1 so that it follows the operating frequency band of the FM receiver circuit 40.

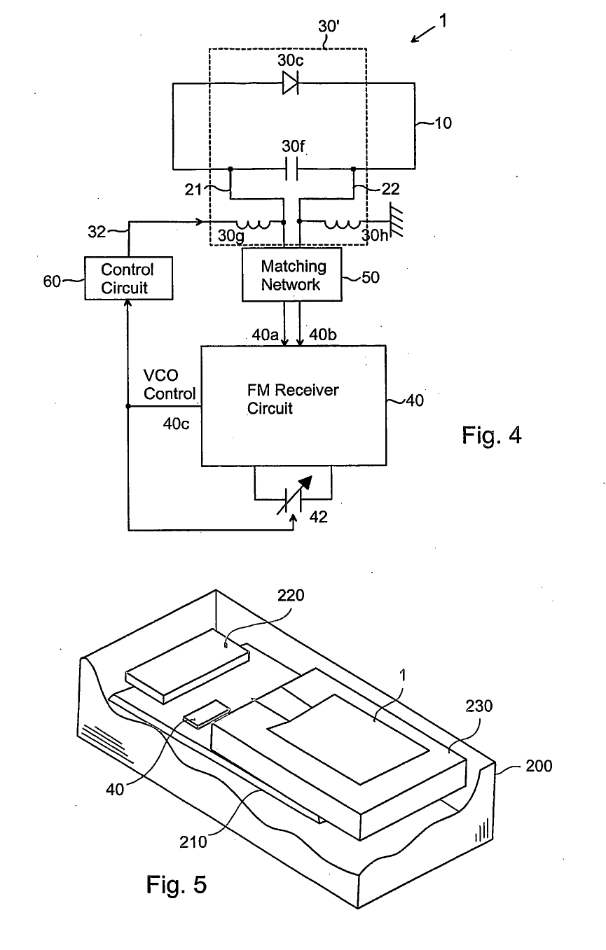

FIG. 4 shows an antenna device arrangement similar to that shown in FIG. 3 but with a different variable impedance designated 30′ and shown within dashed lines. Thus, between the connection points of the feeding portions 21, 22 in the loop there is provided a capacitance 30f. Between the first feeding portion 21 and the control circuit 60 there is provided an first inductance 30g while a second inductance 30h is provided between the second feeding portion 22 and ground. This provides for a controllable impedance in the loop antenna.

It is often preferred to mount components on a PCB. Thus, in the example of FIG. 4, all components 30f-h could be mounted on a PCB, while just the diode 30c is fitted in the radiating element 10.

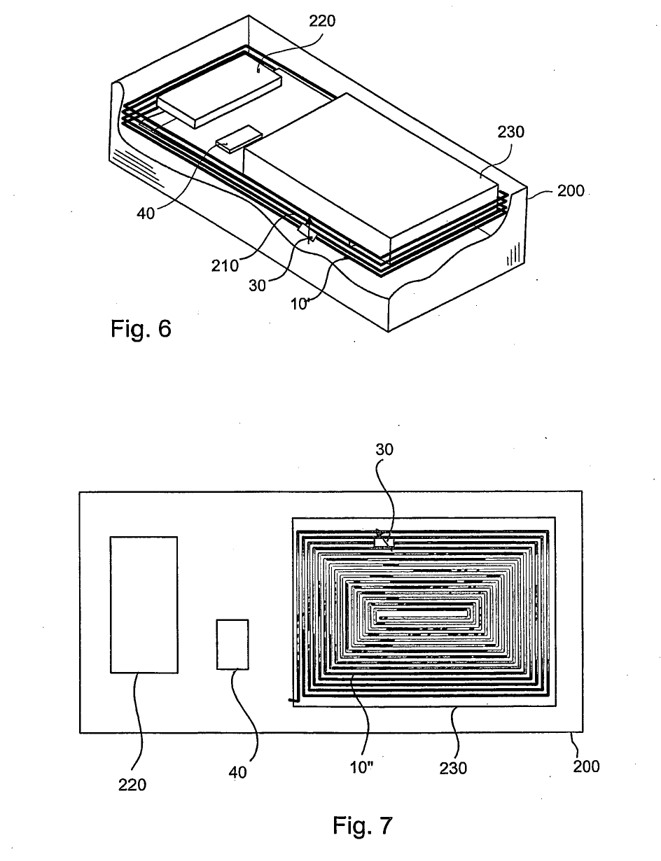

A preferred position of the antenna device according to the invention will now be described with reference to FIG. 5, wherein the general outlines of the casing of a portable radio communication device 200, such as a mobile phone, is depicted. The casing is shown partially cut away so as to not obscure the position of the antenna device, which could be the device shown in FIG. 3.

A printed circuit board (PCB) 210 is provided in the casing, having the circuits (not shown) conventionally found in a mobile phone. On the PCB there is also mounted the FM receiver circuit 40. In the upper portion of the casing there is provided an antenna element 220 for receiving and transmitting RF signals for a mobile phone system, such as a GSM system.

A battery package 230 is also provided towards the back of the casing 200. This battery package is connected to the PCB by means of connectors (not shown). Arranged on the back surface of the battery package is the antenna device 1, preferably provided as a conductive flexible film attached to the package. The feeding portions of the antenna device are connected to the PCB in the same way as the battery, i.e., through connectors arranged on the battery package and co-operating with corresponding connectors on the PCB.

By providing the FM antenna 1 on the battery package, a sufficient distance between the FM antenna and the mobile phone antenna 220 is obtained so as to avoid interference there between.

An alternative antenna configuration is shown in FIG. 6. The radiating element 10′ of a monopole or loop antenna is arranged in several turns outside of the edge of the PCB 210 so as to occupy as little area as possible. It is thus provided along the inside of the casing 200. A controllable electric impedance 30 is arranged somewhere in the monopole antenna so as to make the operating frequency range adjustable. The antenna is connected to the FM receiver circuit 40 in some suitable way. By providing an antenna in several turns, a very long physical length can be obtained in a small area.

In yet an alternative embodiment shown in FIG. 7 the antenna device is provided with a radiating element in the form of a spiral antenna 10″. This antenna pattern is provided on the back side of the battery package 230 mounted in the casing 200 of the portable radio communication device. A spiral antenna pattern provides a relatively broad frequency band and also has an impedance that is suitable for the receiver, about 200 Ohms. With a spiral antenna, the matching network 50 shown in FIGS. 3 and 4 could be omitted.

Also, there are many alternative ways of feeding a spiral antenna. Thus, it could be fed as a monopole or a dipole antenna. It could be fed at the inner end, i.e., the end in the centre of the device, or at the outer end.

A way of shortening the physical antenna length is to arrange any of the above described antenna patterns above a dielectric material. This could be of great importance especially in small sized radio communication devices.

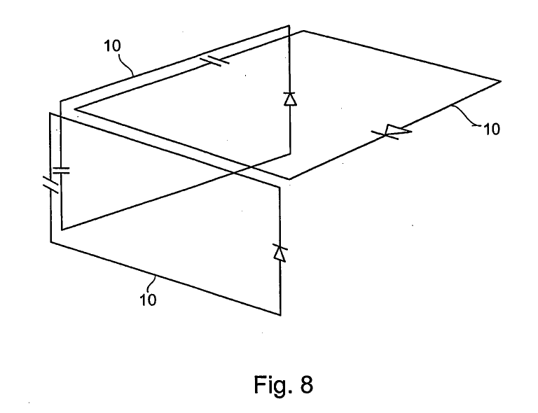

In order to further enhance the reception of FM signals, two or more antenna elements can be combined. In FIG. 8, there is shown how three antenna elements 10 of the above described kind can be positioned in orthogonal relationship in order to eliminate the problem of poor directivity and polarizations. Each radiation element comprises a feeding portion and a controllable electrical impedance as in the previous embodiments. An improvement is also achieved with only two orthogonal antennas.

Preferred embodiments of an antenna device according to the invention have been described. However, the person skilled in the art realises that these can be varied within the scope of the appended claims without departing from the inventive idea. Thus, although a control circuit 60 has been shown in the embodiment of FIG. 3, it will be appreciated that this control circuit in some cases can be omitted.

It is realized that the shape and size of the antenna device according to the invention can be varied within the scope defined by the appended claims. Thus, the exact antenna configurations can be varied so as to correspond to the shape of the radio communication device, desired performance etc.

In the described embodiments, the antenna device has been provided as a flexible film. Other manufacturing processes and materials can of course be used for the antenna device.

The antenna device according to the invention has been shown provided on the back side of a battery package or around the PCB. It will be appreciated that there are alternative ways of placing the antenna device according to the invention. Thus, it could be provided on the inside of the D-cover, on or below the PCB or between PCBs etc.

The controllable electrical impedance has been described as being somewhere in the radiating element itself. It will be appreciated that any means acting as a controllable electrical impedance for the radiating element could be used, also means that are not provided in the radiating element itself.

Although an antenna device for a portable radio communication device has been described with reference to its use in a mobile phone, it will be appreciated that the inventive idea is also applicable to other portable radio communication devices, also devices that are portable but primarily intended for stationary use. Examples thereof could be small clocks, such as travel alarm clocks, or game consoles.

1. An antenna device for a portable radio communication device adapted for receiving radio signals, said antenna device comprising
an internal radiating element (10) comprising at least one feeding portion (21, 22) connected to a receiver circuit (40),
characterised in that
the radiating element (10) comprises an electrical impedance (30; 30′; 30″) that is controllable in dependence on the desired frequency range of the received signals,
wherein the at least one feeding portion (21, 22) is connected to a feeding input (40a, 40b) on the receiver circuit, and
wherein the control input of the controllable electrical impedance (30) is connected to an output (40c) on the receiver circuit (40) intended for the control of the VCO resonance frequency of the receiver circuit.

2. The antenna device according to claim 1, wherein the impedance (30; 30′; 30″) is a capacitive impedance.

3. The antenna device according to claim 2, wherein the electrical impedance is a varactor diode (30).

4. The antenna device according to claim 1, wherein the impedance (30) is an inductive impedance.

5. The antenna device according to any of claims 1-4, wherein the radio signals for which the antenna 5 device is adapted have a frequency below 110 MHz, preferably between 76 and 110 MHz, and even more preferably between 88 and 108 MHz.

6. The antenna device according to any of claims 1-5, wherein the radiating element is a loop (10).

7. The antenna device according to any of claims 1-6, wherein the radiating element (10′) is arranged in several turns.

8. The antenna device according to any of claims 1-7, wherein the radiating element (10) is arranged on a battery package (230).

9. The antenna device according to claim 8, wherein the radiating element (10) is connected to the receiver circuit (40) by means of connectors provided on the battery package (230).

10. The antenna device according to any of claims 1-9, wherein the radiating element (10″) is arranged as a spiral.

11. The antenna device according to any of claims 1-9, wherein the radiating element (10′) of the antenna device is provided outside of the edge of a PCB (210) provided in the radio communication device.

12. The antenna device according to any of claims 1-11, wherein the radiating element (10) is provided above a dielectric material.

13. The antenna device according to any of claims 1-12, comprising at least two orthogonal radiating elements (10), each comprising at least one feeding portion (21, 22) connected to the receiver circuit and an electrical impedance.

14. A portable radio communication device comprising an antenna device according to any of the preceding claims.
